(19) United States
(12) Patent Application Publication
(10) Pub. No.: US 2019/0011001 A1
(43) Pub. Date: Jan. 10, 2019

(54) Emergency Braking of a Flywheel

(71) Applicant: Amber Kinetics, Inc., Union City, CA (US)

(72) Inventors: Seth Robert Sanders, Berkeley, CA (US); Daniel Bakholdin, Newbury Park, CA (US); Matthew K. Senesky, Mountain View, CA (US); Mark J. Holloway, Mountain View, CA (US); Peter Thomas Tennessen, Oakland, CA (US); Roger Nelson Hitchcock, San Leandro, CA (US)

(21) Appl. No.: 16/027,666

(22) Filed: Jul. 5, 2018

Related U.S. Application Data
(60) Provisional application No. 62/529,413, filed on Jul. 6, 2017.

(51) Int. Cl. F16D 57/00; F16D 66/00; F16D 65/14; H02K 7/02

(52) U.S. Cl. CPC F16D 57/00; F16D 66/00; F16D 2066/001; H02K 7/025; F16D 65/14

(57) ABSTRACT

A flywheel device includes an enclosure that surrounds an interior chamber that includes a rotor, which during normal operation is maintained in a vacuum state and spinning, the enclosure includes a first opening, and a valve that attaches to the enclosure, configured to enable, when actuated, ambient air to flow from the exterior of the enclosure into the chamber through the first opening, thus allowing the internal air pressure to rapidly approach ambient air pressure and thereby increase the air drag which acts as a brake on the spinning rotor.

### CROSS REFERENCE TO RELATED APPLICATIONS

This application claims the benefit of priority to U.S. Provisional Application No. 62/529,413, filed on Jul. 6, 2017. It is related to co-pending U.S. patent application Ser. No. 15/662,176 filed on Jul. 27, 2017. All of the foregoing are incorporated by reference herein in their entirety for all purposes.

### BACKGROUND

### 1. Field of Art

This description generally relates to energy storage using flywheels. However, the invention may be applied to other applications where braking of a flywheel is desirable.

### 2. Description of the Related Art

A flywheel is one type of energy storage system that stores energy as rotational kinetic energy. A flywheel rotor is a rotationally symmetric mass that spins while physically coupled, directly or indirectly, to a motor/alternator that itself is electrically coupled to a converter, such as a back-to-back inverter system, constituting an AC-AC conversion subsystem. When power is received for storage, the rotor is driven, increasing the rotational speed of the flywheel rotor. When power is to be extracted, the flywheel rotor drives the motor/alternator. The faster a flywheel rotor spins, the more energy it stores, but the faster it spins, the higher the rotational losses due to aerodynamic drag. To reduce aerodynamic drag, the flywheel may be operated in a chamber which is evacuated, also referred to as a vacuum chamber, to operating pressures that equate to small fractions of an atmosphere. For example, in certain embodiments, the operating pressure range is 0.0001 Torr to 0.100 Torr. (1 ATM=760 Torr).

Many exemplary flywheel energy storage systems include power trains that enable charge and discharge over periods of many minutes to hours. Some of these flywheel energy storage systems store energy at levels that can present hazards to installation hardware, adjacent equipment, and even personnel if in close proximity. The onset of a critical failure may be detected by sensors such as accelerometers, gyros, an enclosure vacuum pressure gauge, magnetic bearing gap or force sensors, and/or an integrated electrical control system. Nevertheless, with a flywheel energy storage system designed for discharge over many minutes or longer, the main energy discharge path may not have adequate power capacity to decelerate the flywheel rotor before the critical failure occurs.

In a flywheel energy storage system designed for long duration applications, like diurnal load shifting that involves hours of charge and discharge each day, the system cost may very well be dominated by the rotor cost. Thus, optimizing rotor cost is a design challenge. It is generally known that in the absence of surface stresses, kinetic energy storage is linearly related to the integral of the principle stresses over the volume of a rotor. Thus, a rotor makes excellent use of its material when stresses are distributed relatively uniformly over the volume. This idea is embodied in the shape factor, defined as:

$${k}_{S} = \frac{W ρ}{M {σ}_{max}} \qquad Eq . 1$$

where W is rotor kinetic energy, M is rotor mass, ρ is the rotor material density, and σₘₐₓ is the largest principal stress magnitude taken over the rotor volume. The expression for the shape factor emphasizes the effectiveness of keeping the maximal stress σₘₐₓ as small as possible. Since stored kinetic energy is linearly related to the volume integral of the sum of the principal stresses, it is clear that keeping the stresses as uniform as possible may be a desirable design criteria.

In order to reduce rotor and flywheel system cost, Eq. 1 also makes clear that a material that maximizes usable strength per dollar cost is advantageous. It turns out that low alloy, high-strength steels are a good choice for this purpose. Further, the use of a steel rotor enables an efficacious realization of a low-cost multi-hour flywheel system.

Steel has an adequately large thermal capacity to sustain only a moderate temperature rise should rotor kinetic energy be converted to thermal energy upon a dissipative braking event. A representative steel alloy has heat capacity of 0.47 J/g-K on a mass basis, and 3.76 J/cm3-K on a volumetric basis. For such a steel rotor with shape factor kₛ of 0.6 (e.g. a solid disk) and operating at an exemplary peak stress of 1000 Mpa, the net temperature rise is about 160 C if all of the rotational kinetic energy is dissipated and stored as thermal energy in the rotor. This analysis presumes uniform temperature distribution throughout the rotor volume. Depending upon the dissipative braking process, only a fraction of the net kinetic energy will be converted to heat in the rotor, resulting in even less net temperature rise. On the other hand, due to the thermal diffusivity of the rotor material, initial temperature rise may be larger on the rotor surface.

Many high strength steel alloys are processed with final tempering temperatures as high as 650 C, and thus may sustain as much as 600 C temperature rise without any mechanical degradation. Further, since centrifugally induced stresses are most intense at the center of a solid rotor structure, even higher temperature exposure on the outer periphery may be tolerated without significant mechanical performance degradation.

Thus, a steel rotor, especially a solid steel rotor, is especially resilient to rapid frictional braking processes.

### SUMMARY

The subject invention includes a device and method for emergency air braking that is especially suited for metal flywheel rotors.

Embodiments relate to a flywheel device that includes an enclosure that surrounds an interior chamber, the interior chamber includes a rotor, which during normal operation is maintained in a vacuum state with the rotor spinning, and the enclosure includes a first opening, and a valve that attaches to the enclosure, configured to enable, when actuated, ambient air to flow from the exterior of the enclosure into the chamber through the first opening thus allowing the internal air pressure to rapidly approach ambient air pressure and thereby increase the air drag which acts as a brake on the spinning rotor.

Embodiments of the flywheel device further include an electronics unit mounted on the enclosure that includes a sensor configured to detect movements, vibration, vacuum pressure, or other physical behaviors characterizing the operation of the flywheel device, a processor communicatively coupled to the sensor, and a memory in communication with the processor for storing instructions, which when executed by the processor, cause the electronics unit to detect an emergency event; and to send a signal to actuate the valve.

Embodiments further relate to a method for emergency braking of a rotor spinning inside a flywheel device, whose steps include receiving a time sequence of sensor data from a sensor, identifying an emergency event, sending an actuation signal to an air valve, the air valve including at least two air ports, the valve mounted on the flywheel device such that one port of the air value is exterior to the flywheel device, and one air valve enables flow through an opening in the flywheel device into an interior chamber of the flywheel device, to enable, upon receiving the actuation signal, opening, by the air valve, the first and second air valves, enabling air to flow from the exterior of the flywheel device into the interior chamber.

### BRIEF DESCRIPTION OF DRAWINGS

Non limiting and non exhaustive embodiments of the present invention are described with reference to the following drawings. In the drawings, like reference numerals refer to like parts throughout the various figures unless otherwise specified.

FIG. 1A is a block diagram of an exemplary flywheel energy storage system according to one embodiment.

FIG. 1B is a block diagram of an exemplary flywheel device that includes a vacuum chamber, according to one embodiment.

FIG. 2 is an isometric view of the top of a flywheel device that enables emergency air braking, according to one embodiment.

FIG. 3 is a top isometric view of the inside of a control unit positioned on a top plate of the flywheel device of FIG. 2, according to one embodiment.

FIG. 4 is an isometric view of the top of a flywheel device that enables emergency air braking, according to one embodiment.

FIG. 5 is a flow diagram of a method performed by a flywheel device to detect an emergency event and apply air braking to a flywheel rotor, according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, or devices. The following detailed description is, therefore, not to be taken in a limiting sense.

As used herein the following terms have the meanings given below:

Vacuum chamber or simply chamber—as used herein, refers to a sealed container, enclosure, or vessel that is fully or partially evacuated of gasses. Essentially, the chamber interior is maintained at a lower pressure than exists exterior to the chamber.

Vacuum state or vacuum—as used herein, refers to a full or partial vacuum in a vacuum chamber. It may be appreciated that it is essentially impossible to maintain a total vacuum, thus a vacuum state refers to a chamber that is maintained at near vacuum and more generally at an air pressure less than ambient air pressure.

### I. Emergency Use of Air to Brake a Flywheel Rotor

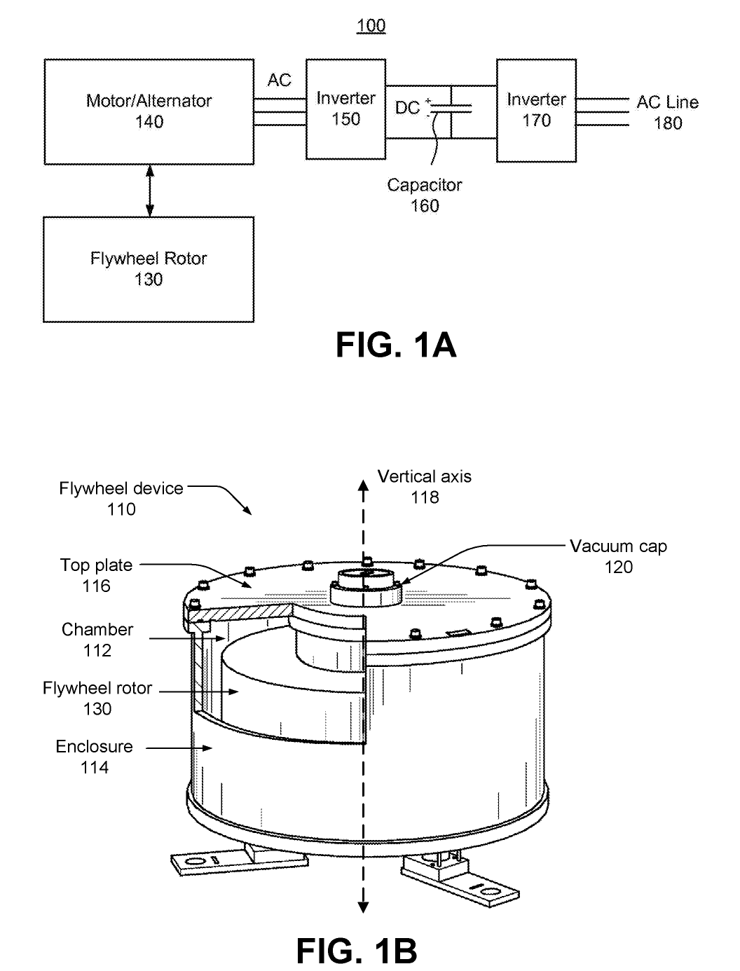

Modern flywheel energy storage systems utilize an evacuated housing to reduce residual air drag on the rotor. Depending upon the details of a given flywheel energy storage system, housing vacuum pressure may vary from 100's of mTorr down to well below 1 mTorr. Requirements are dictated by rotor surface speeds, clearances, and tolerated residual drag losses. For a cylindrical, disk-shaped, or other similarly shaped rotor, maximum surface speed occurs at the periphery. With sufficiently low pressure, the flow regime between the rotor periphery and the housing wall is laminar. The flow regime is characterized by Taylor-Couette analysis, with a progression from laminar flow at low Reynold's numbers to vortical flow, and on to turbulent flow, with increasing Reynold's number. For the geometry of those such as those described hereinbelow with reference to FIG. 1B, the Reynold's number is given by:

$${R}_{e} = \frac{ρ ud}{η} \qquad Eq . 2$$

where ρ is the gas density, η is the gas dynamic viscosity, u is the surface velocity, and d is the clearance between the rotor periphery and the housing wall. As is evident, the Reynold's number increases in relation to rotor rotation speed and gas pressure, noting that dynamic viscosity is only a weak function of gas pressure. Conventionally, laminar flow corresponds to Reynold's numbers less than 2300, whereas turbulent flow corresponds to Reynold's numbers above 4000. The transition from laminar flow through vortical flow and on to turbulent flow regimes is governed by increasing progression of the dimensionless Reynold's number.

In the laminar regime, drag is well approximated with surface shear stress given by

$${σ}_{drag} = η \frac{u}{d} \qquad Eq . 3$$

With low pressure air as the residual gas in the chamber, as already noted, the viscosity is only a weak function of pressure and temperature. While remaining in the laminar flow regime, drag is mainly a function of peripheral speed and clearance gap, as is evident from Eq. 3.

Drag can be reduced by lowering the residual gas pressure beyond the point where the mean free path in the residual gas exceeds the clearance between the rotor periphery and the housing. In such case, the flow is termed molecular, since gas molecules mainly interact with the interior housing wall. With decreasing gas pressure in the molecular flow regime, drag asymptotically approaches zero.

On the other hand, drag increases by many orders of magnitude with the onset of turbulent flow. The transition to turbulent flow can be readily effected by breaking the vacuum and allowing the pressure to approach ambient pressure.

As an example, with an ambient air density of 1.2 kg/m3, a dynamic viscosity of air of 2×10⁻⁵ kg/m-s, a clearance of 0.05 m, and a rotor surface velocity of 400 m/s, the Reynold's number evaluates to 1.2×10⁶. Thus, for this representative or any similar operating point (rotor velocity and peripheral clearance) with ambient air, the flow regime is undoubtedly turbulent. As a second example, with residual gas pressure at 100 mTorr, the Reynold's number evaluates to 160, resulting in laminar flow.

Since exemplary flywheel systems are designed for low drag under either laminar or molecular flow conditions, the drag can be increased dramatically with introduction of ambient pressure air. This pressure increase can be effected with a valve that is controlled manually or automatically in response to an incipient hazardous fault condition or to an operational need to brake the rotor.

Upon introduction of ambient pressure air, drag losses cause heating of the air which circulates throughout the vacuum chamber. Thus, heat is transferred to both the rotor and the housing, but may also be exhausted to the external environment as the internal air pressure rises above ambient pressure due to heating. Thus, the rotor may absorb only a fraction of the developed drag heat, limiting temperature rise only to a fraction of that calculated above. The housing will also absorb some of the heat, but will also transfer a good fraction to its surrounding ambient environment.

Since temperature rises due to an air drag braking event are moderate, the process is not destructive. The flywheel device may be operated again once adjustments, repairs, or maintenance are performed.

### II. Flywheel Energy Storage System

FIG. 1A is a block diagram of an exemplary flywheel energy storage system 100, that includes a vacuum chamber, according to one embodiment. The energy storage system includes a flywheel rotor 130, a motor/alternator 140, a first inverter 150, a capacitor 160, a second inverter 170, and an AC line 180. Energy is drawn from, or delivered to, an AC line 180, such as a three-phase 60 Hz line. The first 150 and second 170 inverters as well as capacitor 160 illustrate an exemplary back-to-back converter system for converting the input alternating current into an alternating current acceptable to the motor/alternator 140. The motor/alternator 140 converts between electrical and mechanical energy, so that energy can be stored in or drawn from the flywheel rotor 130. The motor/alternator 140 is physically coupled to the flywheel rotor 130 either directly or indirectly using a shaft. The motor/alternator 140 is coupled to the remainder of the system 100 via wires or other electrical couplings. Generally, although only one of each component is shown, in practice a flywheel energy storage system 100 may include multiples of each individual component. FIG. 1 is one exemplary type of ac-to-ac conversion system. In general, the inventions described herein pertain to a broad range of ac-to-ac conversion topologies, as well as systems that interface directly to a direct current (dc) line. The latter are of especial relevance for dc microgrid and solar photovoltaic applications.

Flywheel energy storage system 100 includes a flywheel device 110, illustrated in FIG. 1B, which has an enclosure or housing 114. Flywheel device 110 has a flywheel top plate 116 that surrounds a top portion of enclosure 114. In certain embodiments, top plate 116 has a vacuum cap 120 that fastens to a central portion of top plate 116. Typically, the central portion is a cut-out, circular region, which is circular symmetric with respect to a central, vertical axis 118 of flywheel device 110.

The sealed interior of enclosure 114 in which flywheel rotor 130 resides is referred to as vacuum chamber 112, or simply chamber 112. Chamber 112 is fully or partially evacuated of gas or air. Flywheel device 110 includes flywheel rotor 130 and may include other elements of system 100. Chamber 112 is formed by flywheel enclosure 114, top plate 116, and vacuum cap 120.

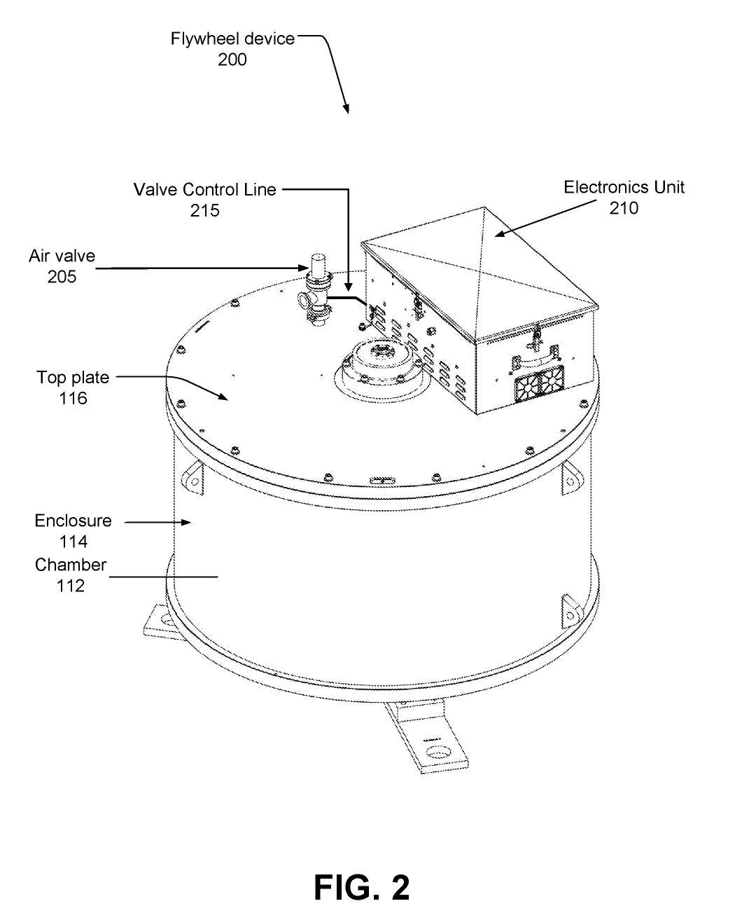

In certain embodiments, flywheel device 110 also has a bottom plate and a bottom vacuum cap. As depicted hereinbelow in FIGS. 2-4, flywheel device 110 may also include a power electronics unit and an emergency valve.

### III. Air Braking Configurations

FIGS. 2-4 illustrate embodiments of a flywheel device that include an emergency air braking solution. An emergency is typically detected by sensors as an unusual vibration or movement of the flywheel device. Such vibrations or movement may be detected by an accelerometer or by other sensors. For example, excessive, or unexpected vibrations or movements may be an indication of an impending bearing failure. Another example of an event that might result in emergency braking would be a speed control failure, i.e. where the rotor spins at an uncontrollable speed. Speed sensing is typically an integral part of the electrical control system, with speed being determined by an encoder or directly from electrical motor/generator variables.

FIG. 2 is an isometric view of the top of a flywheel device 200 that enables emergency air braking, according to one embodiment. Flywheel device 200 adds additional elements to flywheel device 110 to provide control and emergency braking. Flywheel device 200 includes an air valve 205, also commonly referred to as an air control valve, and an electronics unit 210 mounted on flywheel device 110. In certain embodiments, electronics unit 210 and air valve 205 mount to the top of top plate 116. In other embodiments, electronics unit 210 and air valve 205 may be attached to the side or bottom of enclosure 114. In certain embodiments, electronics unit 210 has a housing and the electronics components are housed in the interior.

Air valve 205 is an electrically operated device such as a normally closed valve that has at least two ports, such as a two-port solenoid valve. Air value 205 attaches directly to the exterior of enclosure 114 such that one port is exterior to enclosure 114 and can draw ambient air from the exterior; the other port attaches to a hole in enclosure 114 enabling, when the valve is open, air to flow from the exterior of enclosure 114 into chamber 112. Air valve 205 is controlled by power electronics unit 210 to which it connects via a valve control line 215 that conveys electronic signals. When actuated, air valve 205 opens, allowing air to flow from outside enclosure 114 into chamber 112, which, during normal operating conditions, is operated in a vacuum state. The resulting air drag that occurs in the chamber causes a rapid deceleration of rotor 130 as previously discussed. It may be appreciated that other types of valves or mechanisms may be used other than a 2-way solenoid valve. For example, a four-way valve may be used; or, for example, a 3-port, or 4-port valve may be used. Further, in certain embodiments a manually actuated valve may be used rather than an electronically actuated valve.

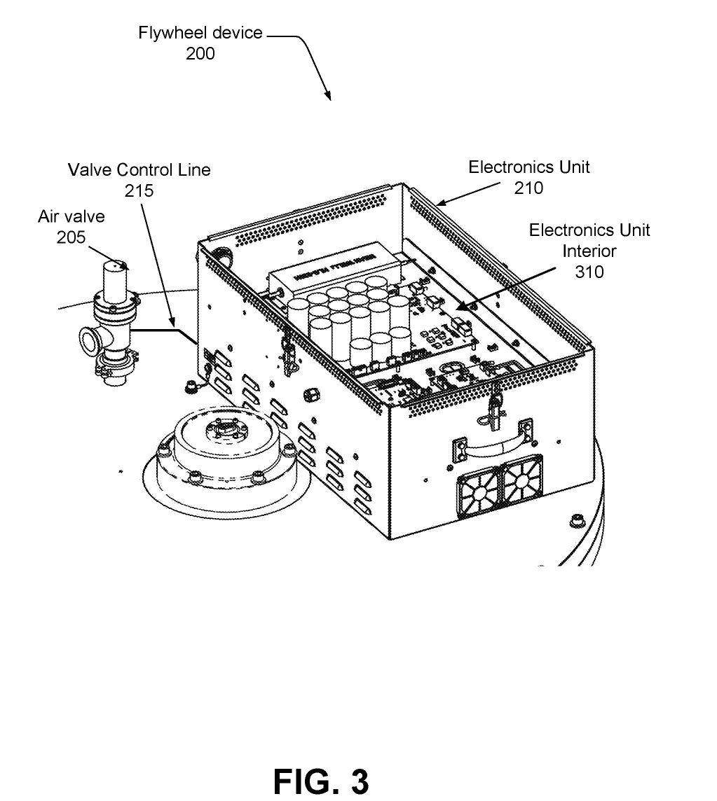

As discussed hereinbelow with reference to FIG. 3, electronics unit 210 includes a processor and at least one sensor that enables it to detect movements, temperature press, and other behavior by flywheel device 200 indicative of potential failure. When an emergency event is detected, electronics unit 210 sends an electronic control signal via valve control line 215 to air valve 205 instructing it to open, thus enabling air to enter vacuum chamber 112. Generally, any configuration of ports is acceptable given the constraints discussed herein.

While the discussion herein refers to ambient air as the gas introduced into chamber 112 to effect braking other gases may be used. In particular, pressurized dry nitrogen may be used.

FIG. 3 is a top isometric view of the interior of electronics unit 200. Aspects of an electronics unit such as electronics unit 200 are described in co-pending U.S. patent application Ser. No. 15/662,176 filed on Jul. 27, 2017.

Electronics unit 210 has an electronics unit interior 310 that includes power electronics circuits with components such as sensors, processors, static computer memory for storing data and program instructions, dynamic computer memory for storing data, network adapters that perform communications, and circuits for controlling and monitoring flywheel device 200. Typically, the sensors include one or more acceleration sensors that measure acceleration of flywheel device 200, one or more temperature sensors that measure the temperature inside chamber 112 and inside power electronics unit interior 310, one or more pressure sensors that measure the air pressure inside chamber 112, one or more gyroscopes that detect orientation, and one or more acoustic sensors that sense acoustic vibrations. In other embodiments, different and/or additional sensors may be used.

The processor is capable of determining emergency events based on a time sequence of sensor data received from each sensor. Table 1, hereinbelow, lists a number of potential emergency events that might result in a triggering of the air braking mechanism.

TABLE 1
Potential Emergency Events

| Emergency | Applicable | |
|---|---|---|
| Event | Sensor | Description |
| Abnormal | Accelerometer | An abnormal movement is typically a |
| movement | | sudden, or otherwise large movement, |
| | | such as resulting from equipment |
| | | failure, or an earthquake. |
| Excessive | Accelerometer | Excessive vibration may occur due to |
| Vibration | | equipment malfunction, such as a |
| | | mechanical or magnetic bearing failure. |
| Excessive | Temperature | The temperature rising above a |
| temperature | | threshold value in the interior chamber |
| | | or electronics unit may be identified |
| | | as an emergency event . . . |
| Pressure loss | Pressure | Detection of gradual loss of pressure |
| in chamber | | in the chamber |

Detected events such as those listed in Table 1 might result in an immediate triggering of the air braking mechanism; alternatively they might cause a situation to be monitored for a period of time, e.g. using a failsafe timer, after which the air braking mechanism is triggered if the triggering event is still detected or conditions have not sufficiently returned towards a range identified as normal or safe.

In addition to the sensor-detected emergency events, the air braking mechanism can be explicitly triggered by an operator. Examples of when air braking might be explicitly triggered include: natural disasters such as earthquakes, floods, and fires (either when they occur or if they are impending) and to prepare for a service call.

Upon detecting an emergency event, the processor initiates air braking by sending a signal via valve control line 215 to air valve 205 instructing it to open.

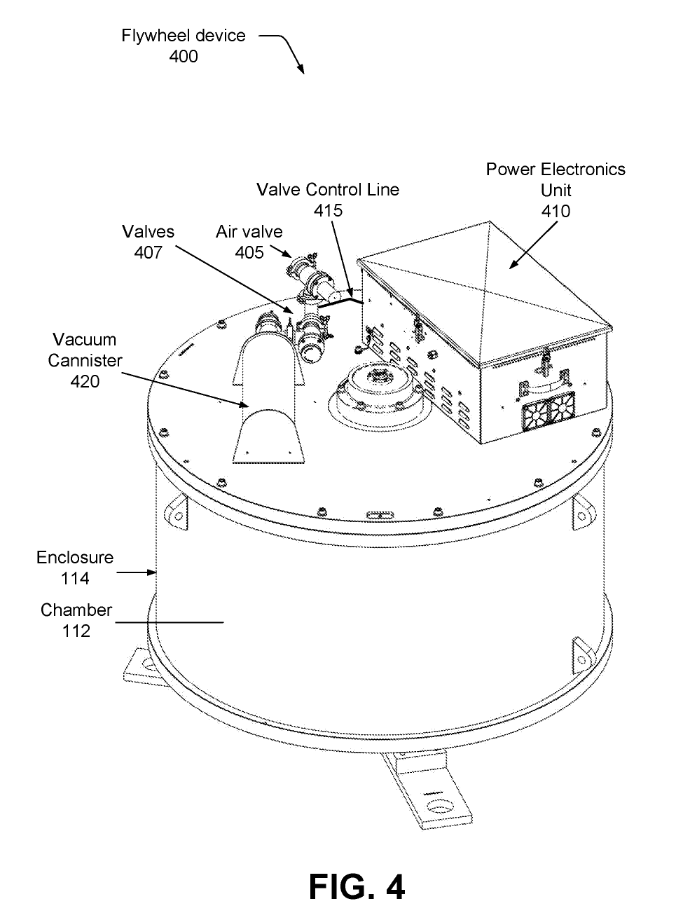

FIG. 4 is an isometric view of the top of a flywheel device 400 that enables emergency air braking, according to one embodiment. Flywheel device 400 is similar to flywheel device 300 with the exceptions that (1) it includes a vacuum cannister 420, and (2) that an air valve 405 is mounted inline with vacuum canister 420 using one or more valves 407. Air valve 405 is controlled by power electronics unit 410. Generally, vacuum canister 420 contains desiccants and/or other chemicals used in chamber 112 to assist in maintaining a vacuum. In certain embodiments, to minimize the number of penetrations into chamber 112 vacuum cannister 420 connects via valves 407 with air valve 405. The ensemble is controlled by one or more valve control lines 415.

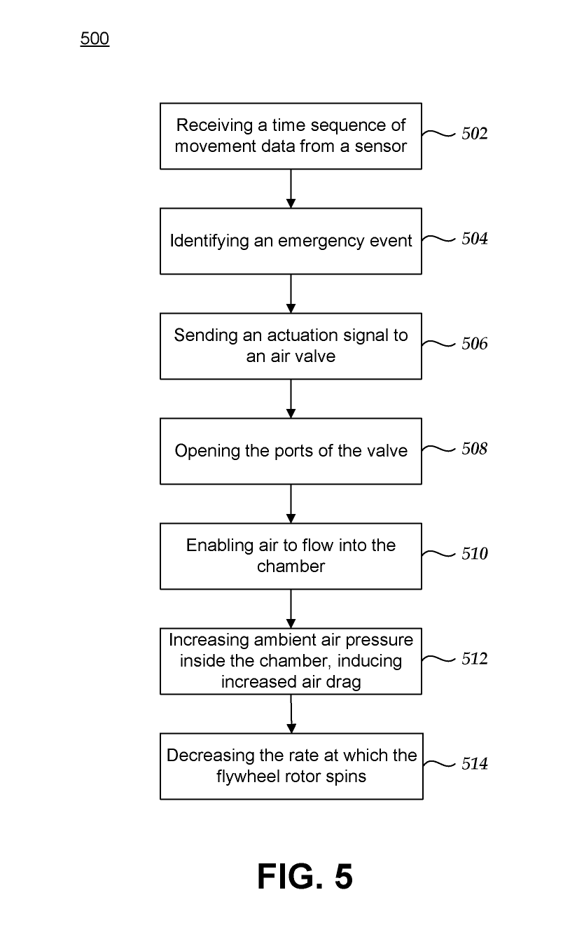

FIG. 5 is a flow diagram of a method 500 performed by a flywheel device such as flywheel device 200, 300 or 400, according to one embodiment. At step 502 a processor in an electronics unit receives a time sequence of movement data from a sensor. At step 504 the processor identifies that a sequence of data indicates abnormal events and identifies or declares an emergency event. Note that not all abnormal movements and events may rise to the state of an emergency immediately; in certain cases, a magnitude or time threshold or other rule may be used to declare an emergency event due to a situation that persists for a period of time.

At step 506 the electronics unit sends an actuation signal to an air valve that is mounted on the enclosure or top plate of the flywheel rotor. The valve has at least two air ports. At step 508, upon receiving the actuation signal, the valve opens the two ports enabling air to flow from the first port through the second, where the first port enables air to flow from the exterior of the flywheel device or enclosure and the second port enables air to flow into an interior chamber of the flywheel device in which a rotor is spinning.

At step 512 the rapid inflow of ambient air increases the air pressure inside the interior chamber resulting in increased air drag. As a result of the air drag, the rate at which the flywheel rotor spins decreases, i.e. the rotor slows appreciably and may even completely stop rotating.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A device, comprising:
an enclosure that surrounds an interior chamber, which during normal operation is maintained in a vacuum state, wherein the enclosure includes a first opening;
a flywheel rotor disposed within the interior chamber; and
a valve that attaches to the enclosure, configured to enable, in response to an actuation signal indicating that a reduction in rotation speed of the flywheel rotor is desired, ambient air to flow from the exterior of the enclosure into the chamber through the first opening.

2. The device of claim 1, further comprising:
an electronics unit, comprising:
a sensor configured to detect movements of the flywheel device;
a processor communicatively coupled to the sensor; and
a memory in communication with the processor for storing instructions, which when executed by the processor, cause the electronics unit:
to detect an emergency event; and
to send a signal to actuate the valve.

3. The device of claim 2, wherein the at least one sensor is selected from the group consisting of an acceleration sensor, a temperature sensor, a pressure sensor, a gyroscope and an acoustic sensor.

4. The device of claim 2, wherein an emergency event is selected from the group consisting of an abnormal movement, an excessive vibration, an excessive temperature and a pressure loss in the chamber.

5. The device of claim 1, wherein the valve has at least a first port and a second port, wherein the first port is exterior to the enclosure and the second port attaches to the first opening, enabling, when the valve is open, air to flow from the exterior of enclosure into the interior chamber.

6. The device of claim 1 wherein the flywheel rotor spins during normal operation, and wherein upon receiving the actual signal the valve opens, enabling ambient air to flow into the interior chamber thus allowing the internal air pressure to rapidly approach ambient air pressure and thereby increase the air drag which acts as a brake on the spinning flywheel rotor.

7. The device of claim 1 wherein the enclosure comprises a plate that fastens to the enclosure and wherein the first opening is an opening in the plate and the valve attaches to the plate.

8. The device of claim 6 wherein the plate is a top plate that attaches to the top of the enclosure.

9. The device of claim 1 wherein the electronics unit is mounted on the enclosure.

10. A method for emergency braking of a flywheel rotor spinning inside an interior chamber of a flywheel device, the method comprising:
receiving a time sequence of sensor data from a sensor;
identifying an emergency event based on the time sequence of sensor data;
sending an actuation signal to an air valve, the air valve including at least a first air port and a second air port, the valve mounted on the flywheel device such that the first air port of the air valve is connected to an exterior of the flywheel device and the second air port of the air valve is connected to the interior chamber of the flywheel device; and
upon receiving the actuation signal, enabling, by the air valve, air to flow from the exterior of the flywheel device into the interior chamber.

11. The method of claim 10, the method further comprising:
increasing the ambient air pressure inside the interior chamber rapidly, as the air flows in, thus inducing air drag; and
slowing the rate at which the flywheel rotor spins due to the increased air drag in the interior chamber.

12. The method of claim 10, wherein the sensor is selected from the group consisting of an acceleration sensor, a temperature sensor, a pressure sensor, a gyroscope and an acoustic sensor.

13. The method of claim 10, wherein the sensor is mounted on the flywheel device.

14. The method of claim 10, wherein an emergency event is selected from the group consisting of an abnormal movement, an excessive vibration, an excessive temperature and a pressure loss in the chamber.

15. The method of claim 10, wherein when the valve receives the actuation signal it opens and ambient air flows into the interior chamber thus allowing the internal air pressure to rapidly approach ambient air pressure and thereby increase the air drag which acts as a brake on the spinning rotor.
